(19) United States
(12) Patent Application Publication
(10) Pub. No.: US 2025/0168727 A1
(43) Pub. Date: May 22, 2025

(54) ELECTRONIC DEVICE, CONTROL METHOD, AND STORAGE MEDIUM

(71) Applicant: CANON KABUSHIKI KAISHA, Tokyo (JP)

(72) Inventor: Takafumi Ishii, Kanagawa (JP)

(21) Appl. No.: 18/950,379

(22) Filed: Nov. 18, 2024

(30) Foreign Application Priority Data
Nov. 22, 2023 (JP) 2023-198525

(51) Int. Cl. H04W 36/08; H04L 61/5014; H04W 48/20; H04W 84/12

(52) U.S. Cl. CPC H04W 36/08; H04L 61/5014; H04W 48/20; H04W 84/12

(57) ABSTRACT

An electronic device includes: a reception unit that receives a change request for a connection destination AP from a currently connected access point (AP); a change unit that changes a connection destination AP on a basis of the change request; a confirmation unit that, when changing via the change unit, confirms whether or not communication can be performed with a specific external device communicated with before an AP change via an AP after change; and a control unit that performs control so that, relating to a result of confirmation by the confirmation unit, in a case where communication cannot be performed with the specific external device, a specific processing for requesting IP address allocation is executed, and in a case where communication can be performed with the specific external device, the specific processing is not executed.

### BACKGROUND OF THE INVENTION

### Field of the Invention

The present invention relates to an electronic device that can connect via a wireless LAN, a control method therefor, and a storage medium.

### Description of the Related Art

In the field of extended service sets (ESS) configured of a plurality of access points (AP), a known technology dynamically switches connection destination APs for efficient data exchange between the APs and a station (STA). When it is determined to switch the connection destination AP on the basis of the congestion of the AP the STA is connected to, the availability of other APs, the radio wave situation, and the like, the currently connected AP transmits a connection destination AP change request to the STA. When the STA receives the change request, the STA can connect to an appropriate AP by switching the connection destination AP in accordance with the request.

Japanese Patent Laid-Open No. 2021-175068 describes the following as processing for requesting a connection destination AP change from a router provided with an AP function to a currently connected wireless client. A mobile router (MR1) that can connect to a plurality of wireless clients checks whether a wireless client terminal supports IEEE 802.11v. Whether the wireless client terminal supports IEEE 802.11v is determined from an association request frame that is transmitted when the wireless client terminal wirelessly connects to the MR1. If the wireless client terminal supports IEEE 802.11v, a BSS transition management (BTM) request frame is transmitted to the corresponding wireless client terminal. A BSS transition candidate list entries field of the BTM request frame designates the BSSID of a master unit router RT2 as the connection destination. This prompts the connection destination AP of the client terminal to be switched, and the wireless client terminal switches the connection destination AP from the MR1 to the RT2 in accordance with the received BTM request frame.

### SUMMARY OF THE INVENTION

The present invention provides a mechanism that can reduce the amount of time needed to resume communication with an external apparatus when changing the connection destination AP.

The present invention in one aspect provides an electronic device comprising: at least one memory and at least one processor which function as: a reception unit configured to receive a change request for a connection destination AP from a currently connected access point (AP); a change unit configured to change a connection destination AP on a basis of the change request; a confirmation unit configured to, when changing via the change unit, confirm whether or not communication can be performed with a specific external device communicated with before an AP change via an AP after change; and a control unit configured to perform control so that, relating to a result of confirmation by the confirmation unit, in a case where communication cannot be performed with the specific external device, a specific processing for requesting IP address allocation is executed, and in a case where communication can be performed with the specific external device, the specific processing is not executed.

According to the present invention, the amount of time needed to resume communication with an external apparatus can be reduced when changing the connection destination AP.

Further features of the present invention will become apparent from the following description of exemplary embodiments with reference to the attached drawings.

### BRIEF DESCRIPTION OF THE DRAWINGS

FIG. 1 is a diagram illustrating a system configuration.

FIG. 2A and 2B are diagrams illustrating the configuration of an MFP.

FIG. 3A to 3C are diagrams illustrating an operation display unit of an MFP.

FIG. 4A and 4B are diagrams illustrating the configuration of a mobile terminal apparatus.

FIG. 5 is a diagram illustrating the configuration of an access point.

FIG. 6 is a sequence diagram for describing the processing executed in response to a connection destination change request from an AP.

FIGS. 7A and 7B are flowcharts illustrating the processing executed in response to a connection destination AP change request.

FIG. 8 is a flowchart illustrating the processing of S709 and S713.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

In a case where the STA receives a connection destination AP change request and the connection destination AP is changed, it is not always the case that the IP address allocated to the electronic device before the connection destination AP change can be continuously used. However, if processing to request an IP address allocation is executed each time the connection destination AP is changed, time is then needed to resume communication with another device that was being performing before the connection destination AP change.

According to the present disclosure, the amount of time needed to resume communication with an external apparatus can be reduced when changing the connection destination AP.

### First Embodiment

### System Configuration

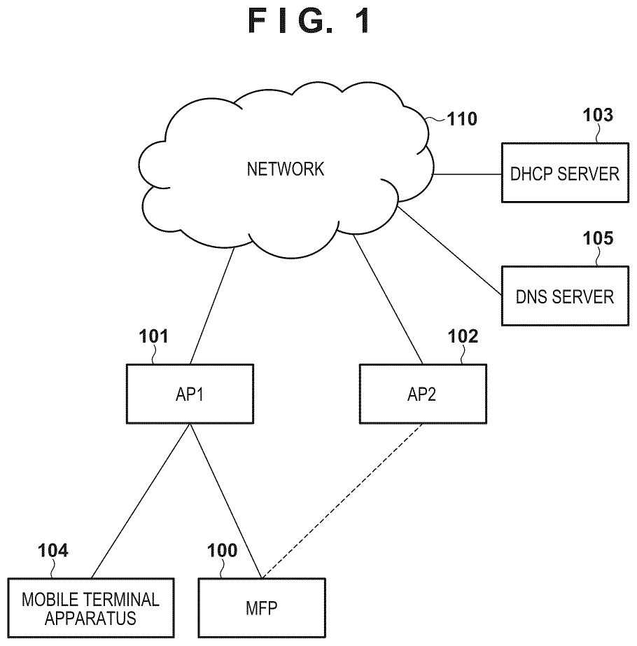

FIG. 1 is a diagram illustrating an example configuration of a system according to the present embodiment. The present system, in this example, is a wireless communication system enabling wireless communication between a plurality of communication apparatuses. In the example of FIG. 1, the communication apparatus include a mobile terminal apparatus 104, an MFP 100, access points AP 101 and AP 102, a dynamic host configuration protocol (DHCP) server 103, a domain name system (DNS) server 105, and a network 110. Note that in the drawings, the AP 101 may be displayed as AP1 and the AP 102 may be displayed as AP2. The mobile terminal apparatus 104 is an information processing apparatus with a wireless communication function such as wireless LAN. Note that hereinafter, wireless LAN may be referred to as WLAN. The mobile terminal apparatus 104 may be a personal digital assistant (PDA) or similar personal information terminal, a mobile phone (smartphone), a digital camera, a personal computer, or the like.

The MFP 100 is a printing apparatus with a print function and may also have a read function (scanner), a fax function, and a phone function. Also, the MFP 100 according to the present embodiment has a communication function enabling wireless communication with the mobile terminal apparatus 104. Also, in the present embodiment described herein, the MFP 100 is used as an example, but no such limitation is intended. For example, instead of the MFP 100, a scanner apparatus, a projector, a mobile terminal, a smartphone, a note PC, a tablet terminal, a PDA, a digital camera, a music playback device, a television, a smart speaker, or the like with a communication function may be used. Note that MFP is an acronym for multifunction peripheral.

The AP 101 operates as a WLAN base station apparatus provided separated to (outside of) the mobile terminal apparatus 104 and the MFP 100. A communication apparatus with a WLAN communication function can communicate in WLAN infrastructure mode via the AP 101. Note that hereinafter, access point may be referred to as AP. Also, infrastructure mode may be referred to as wireless infrastructure mode. The AP 101 wirelessly communicates with a communication apparatus permitted (authenticated) to connect to it, and the communication apparatus relays wireless communication to other communication apparatuses. Also, the AP 101 may be connected to a wired communication network, for example, and relay communication between a communication apparatus connected to this wired communication network and other communication apparatuses wirelessly connected to the AP 101.

The AP 102 has similar functions to the AP 101, and the MFP 100 switches connection from the AP 101 to the AP 102 as necessary. The DHCP server 103 is connected to the MFP 100 via the AP 101 and the network 110 and provides a service to the MFP 100 by responding to a request from the MFP 100. Note that the DHCP server 103 in FIG. 1 is illustrated as being connected to the AP 101 and the AP 102 as a separated device. However, the AP 101 and the AP 102 may have a DHCP server function. The DNS server 105 is connected to the MFP 100 and the mobile terminal apparatus 104 via the AP 101 and the network 110 and provides a service for name resolution by responding to a request from the MFP 100 or the mobile terminal apparatus 104. Here, the network 110 may be the so-called Internet, but a closed internal company network or a cellular network may be used.

### MFP External Appearance

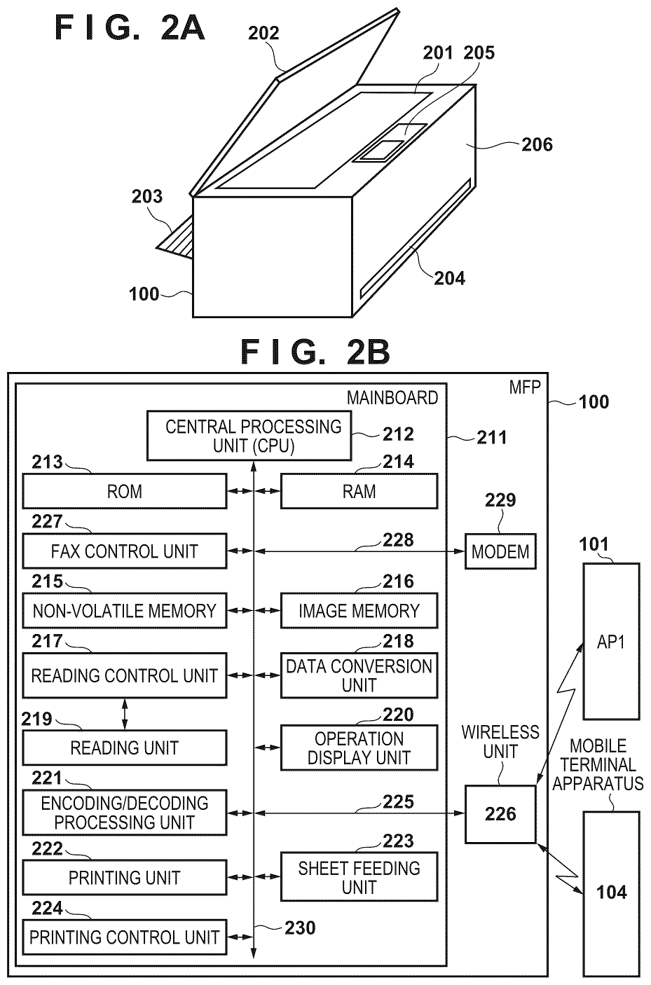

FIG. 2A illustrates an example of the external appearance of the MFP 100. The MFP 100 includes, for example, a platen 201, a document cover 202, a printing paper insertion opening 203, a printing paper discharge opening 204, and an operation display unit 205. The platen 201 is a platform for placing documents to be read. The document cover 202 is a cover used to press against a document placed on the platen 201 or prevent light from a light source illuminating the document escaping out during reading. The printing paper insertion opening 203 is an insertion opening where various sizes of sheets can be set. The printing paper discharge opening 204 is a discharge opening where sheets are discharged after printing. The sheets set in the printing paper insertion opening 203 are conveyed one sheet at a time to a printing unit and are discharged from the printing paper discharge opening 204 after printing has been performed by the printing unit. The operation display unit 205 includes character input keys, a cursor key, an enter key, a cancel key, and/or similar keys; LEDs; a LCD; and the like. The operation display unit 205 is configured to receive operations from the user relating to the activation of various types of functions of an MFP and various types of settings. Also, the operation display unit 205 may include a touch panel display. The MFP 100 has a WLAN wireless communication function and includes a wireless communication antenna 206 for wireless communication that is not necessarily visible from the outside. The MFP 100 can perform wireless communication via WLAN in a frequency range of the 2.4 GHz band or the 5 GHz band in a similar manner to the mobile terminal apparatus 104.

### MFP Configuration

FIG. 2B illustrates an example of the configuration of the MFP 100. The MFP 100 includes a mainboard 211 for performing main control of the apparatus itself and a wireless unit 226, which is a single communication module for performing WLAN communication using at least one shared antenna. Also, the MFP 100 includes a modem 229 for performing wired communication, for example. The mainboard 211 includes, for example, a CPU 212 (central processing unit), a ROM 213, a RAM 214, a non-volatile memory 215, an image memory 216, a reading control unit 217, a data conversion unit 218, a reading unit 219, and an encoding/decoding processing unit 221. Also, the mainboard 211 includes, for example, a printing unit 222, a sheet feeding unit 223, a print control unit 224, and an operation display unit 220. These functional units in the mainboard 211 are connected to one another via a system bus 230 managed by the CPU 212. Also, the mainboard 211 and the wireless unit 226 are connected via a dedicated bus 225, for example, and the mainboard 211 and the modem 229 are connected via a bus 228, for example.

The CPU 212 is a system control unit including at least one processor that controls the entire MFP 100. The processing of the MFP 100 described below is, for example, implemented by the CPU 212 executing programs stored in the ROM 213. Note that dedicated hardware may be prepared for each item of processing. ROM 213 stores control programs executed by the CPU 212, embedded OS programs, and the like. In the present embodiment, in a similar manner, the CPU 212 executes the control programs stored in the ROM 213 under the management of the embedded OS stored in the ROM 213 to perform software control such as scheduling and task switching.

The RAM 214 is constituted by an SRAM or the like. The RAM 214 stores data such as program control variables and the like, setting values registered by the user, MFP 100 management data, and the like. Also, the RAM 214 may be used as a buffer for various types of work. The non-volatile memory 215 is constituted by memory such as flash memory, for example, and continually stores data even after power to the MFP 100 is turned off. The image memory 216 is constituted by a memory such as a DRAM. The image memory 216 stores image data received via the wireless unit 226, image data processed by the encoding/decoding processing unit 221, and the like. Note that the memory configuration of the MFP 100 is not limited to the configuration described above. The data conversion unit 218 analyzes data of various formats, converts image data into print data, and the like.

The reading control unit 217 controls the reading unit 219 (for example, a contact image sensor (CIS)) to optically read the document placed on the platen 201. The reading control unit 217 converts the image obtained by optically reading the document into electrical image data (an image signal) for output. The reading control unit 217 may perform various types of processing such as binarization processing and halftone processing at this time and then output the image data.

The operation display unit 220 is the operation display unit 205 described with reference to FIG. 2A and displays to a display according to display control by the CPU 212 and generates signals in accordance with received user operations.

The encoding/decoding processing unit 221 performs encoding processing and decoding processing and enlargement and reduction processing of image data (JPEG, PNG, and the like) handled by the MFP 100. The sheet feeding unit 223 holds sheets for printing. The sheet feeding unit 223 can supply sheets that have been set under the control of the print control unit 224. The sheet feeding unit 223 may include a plurality of sheet feeding units for holding a plurality of types of sheets in one apparatus and can control which sheet feeding unit to feed from under the control of the print control unit 224.

The print control unit 224 executes various types of processing such as smoothing processing, print density correction processing, and color correction on the image data to be printed and outputs post-processing image data to the printing unit 222. The printing unit 222 is configured to execute an inkjet printing process by discharging ink supplied from ink tanks from a print head and printing an image on a printing medium such as a sheet. Note that the printing unit 222 may be configured to execute an electro-photographic or other printing process. Also, the print control unit 224 may periodically read out information of the printing unit 222 and update status information such as ink tank remaining amount, print head state, and the like stored in the RAM 214.

The wireless unit 226 is a unit that can provide a WLAN communication function and, for example, can provide a function similar to a combination with a WLAN unit 429 of the mobile terminal apparatus 104. In other words, the wireless unit 226, following a WLAN protocol, converts data into packets and transmits packets to other devices or restores packets from other external devices into the original data and outputs them to the CPU 212. The wireless unit 226 can communicate as a station compliant with the IEEE 802.11 standard series. In particular, communication is possible as a station compliant with IEEE 802.11a/b/g/n/ac/ax. Hereinafter, station may be referred to as STA. Also, communication is possible as an STA supporting Wi-Fi Agile Multiband (trademark).

The wireless unit 226 supports IEEE 802.11ax, that is, Wi-Fi6 (trademark) and can execute processing compliant with IEEE 802.11ax. In other words, the MFP 100 can process as an STA supporting (compliant with) OFDMA and/or can operate (process) as an STA supporting (compliant with) TWT. OFDMA is an abbreviation for orthogonal frequency-division multiple access. TWT is an abbreviation for target wake time. As TWT is supported, the data communication timing from the master unit to the STA is adjusted. The wireless unit 226 (MFP 100), which is an STA, transitions the communication function to a sleep state when signal reception standby is not required. This can reduce power consumption. Also, the wireless unit 226 also supports Wi-Fi6E (trademark). In other words, communication in the 6 GHz band (5.925 GHz to 7.125 GHz) can be performed. The target band for dynamic frequency selection (DFS) in the 5 GHz band is not in the 6 GHz band. Thus, with communication in the 6 GHz band, communication disconnections due to DFS standby time do not occur. Thus, better communication can be expected.

Note that the mobile terminal apparatus 104 and the MFP 100 can perform P2P (WLAN) communication based on WFD, and the wireless unit 226 has a software access point (software AP) function or a group owner function. In other words, the wireless unit 226 can configure a P2P communication network, determine a channel to use for P2P communication, and the like.

### MFP Operation Display Unit

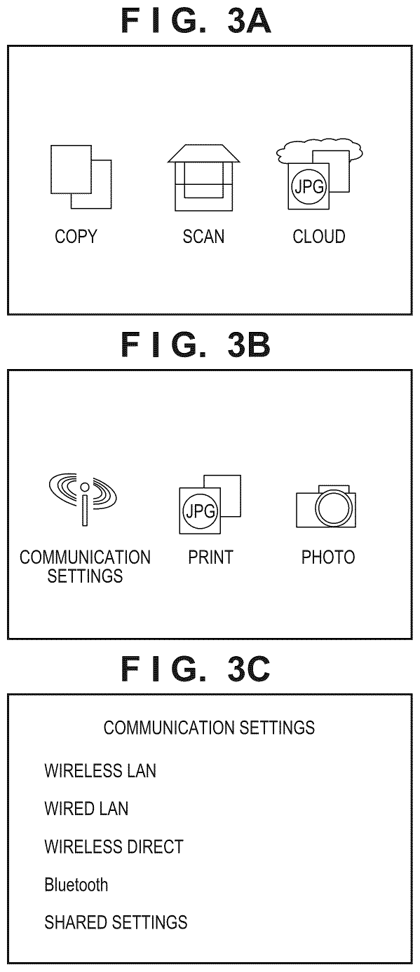

FIG. 3A to 3C schematically illustrate example of a screen display on a display (touch panel display) including in the operation display unit 220 of the MFP 100. FIG. 3A is an example of a home screen displayed when the power of the MFP 100 is turned on and no operations such as printing or scanning are being performed (idle state, standby state). In FIG. 3A, display items (menu items) corresponding to copy, scan, and cloud are displayed. Cloud is a menu item relating to a cloud function using Internet communication. When one of the menu items is selected via operation of a key or the touch panel, the MFP 100 may start executing the corresponding setting or function. The MFP 100 can seamlessly display a screen different from that of FIG. 3A when a key or touch panel operation on the home screen of FIG. 3A is received.

FIG. 3B is an example of a display of another part of the home screen and is a screen transitioned to from the state of FIG. 3A via an operation (left or right slide operation or the like) to display another page of the home screen. In FIG. 3B, display items (menu items) corresponding to communication settings, print, and photo are displayed. When one of these menu items is selected, the function corresponding to the selected menu item, that is, the print function, the photo function, or the communication settings, is executed.

FIG. 3C is an example of a display of a menu screen for communication settings displayed when communication settings is selected on the screen of FIG. 3B. On the menu screen for communication settings, “Wireless LAN”, “Wired LAN”, “Wireless Direct”, “Bluetooth”, and “Shared Settings” are displayed as menu items (options). “Wireless LAN”, “Wired LAN”, and “Wireless Direct” are menu items for LAN settings, and from these items, wired connection settings, wireless infrastructure mode on/off settings, WFD, SoftAP mode, or similar P2P mode on/off settings, and the like can be set. When the “Wireless LAN” item is selected and wireless LAN is set to on by a user operation, the wireless infrastructure mode is turned on. When the “Wireless direct” item is selected and wireless direct is set to on by a user operation, the P2P (WLAN) mode is turned on. On this screen, a shared settings menu relating to each connection state is also displayed. Also, the user can set the wireless LAN frequency range and frequency channel and the like from this screen.

### Mobile Terminal Apparatus External Appearance

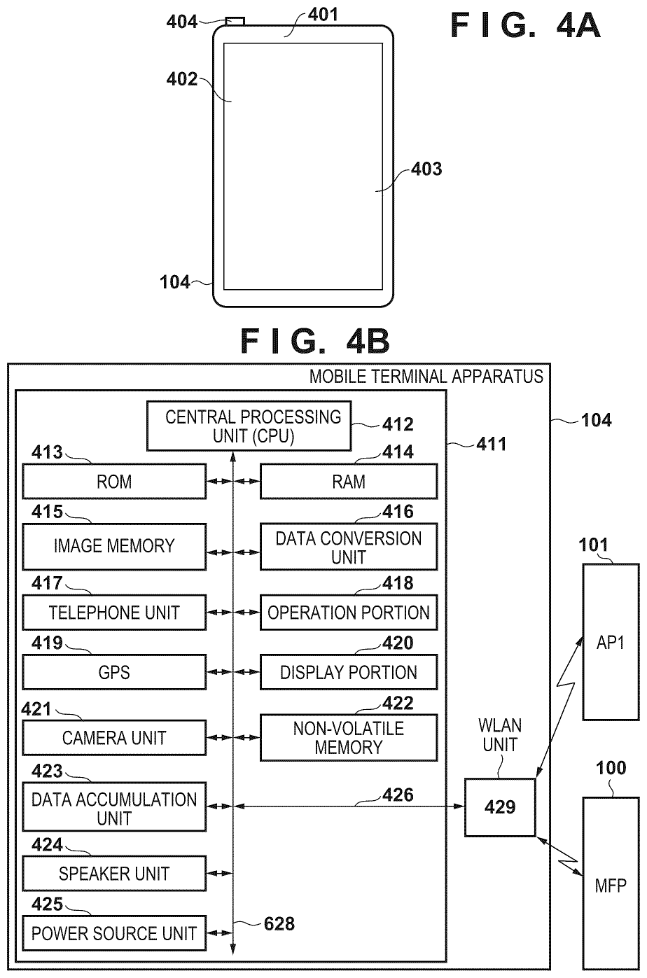

FIG. 4A is a diagram illustrating an example of the external appearance configuration of the mobile terminal apparatus 104. In the present embodiment, in this example, the mobile terminal apparatus 104 is a typical type of smartphone. Note that the mobile terminal apparatus 104, for example, includes a display portion 402, an operation portion 403, and a power key 404. The display portion 402 is a display including a liquid crystal display (LCD) display mechanism, for example. Note that the display portion 402 may display information using a light-emitting diode (LED), for example. Also, the mobile terminal apparatus 104 may have a function of outputting information via audio in addition to or instead of the display portion 402. The operation portion 403 includes physical keys such as keys and buttons, a touch panel, and the like for detecting a user operation. Note that in the present example, since displaying information on the display portion 402 and receiving user operation via the operation portion 403 is performed using a common touch panel display, the display portion 402 and the operation portion 403 is implemented using a single apparatus. In this case, for example, button icons and a software keyboard are displayed using a display function via the display portion 402, and the user touching these sections is detected by an operation reception function via the operation portion 403. Note that the display portion 402 and the operation portion 403 may be separated, and a piece of hardware for display and a piece of hardware for operation reception may be individually prepared. The power key 404 is a physical key for receiving a user operation for turning the power of the mobile terminal apparatus 104 on or off.

The mobile terminal apparatus 104 includes a WLAN unit 401 that provides a WLAN communication function and is not necessarily visible from the outside. The WLAN unit 401 is configured to execute data (packet) communication in a WLAN system compliant with the IEEE 802.11 standard series (IEEE 802.11a/b/g/n/ac/ax and the like), for example. Also, communication is possible as an AP supporting Wi-Fi Agile Multiband (trademark). However, no such limitation is intended, and the WLAN unit 401 may be configured to execute WLAN communication compliant with another standard. Note that in this example, the WLAN unit 401 can communicate on both a 2.4 GHz frequency band channel and a 5 GHz frequency band channel. Also, the WLAN unit 401 can execute communication based on WFD, communication using a SoftAP mode, communication using a wireless infrastructure mode, and the like. Operations in these modes will be described below.

### Mobile Terminal Apparatus Configuration

FIG. 4B illustrates an example of the configuration of the mobile terminal apparatus 104. The mobile terminal apparatus 104 in this example includes a mainboard 411 for executing main control of the apparatus itself and the WLAN unit 429 for WLAN communication. The mainboard 411 includes, for example, a CPU 412, a ROM 413, a RAM 414, an image memory 415, a data conversion unit 416, a telephone unit 417, a GPS 419, a camera unit 421, a non- volatile memory 422, a data accumulation unit 423, a speaker unit 424, and a power source unit 425. Here, CPU is an acronym for central processing unit, ROM is an acronym for read only memory, RAM is an acronym for random access memory, and GPS is an acronym for global positioning system. The mobile terminal apparatus 104 also includes a display unit 420 and an operation unit 418. Each functional unit in the mainboard 411 is connected to one another via a system bus 628 managed by the CPU 412. Also, the mainboard 411 and the WLAN unit 429 (the WLAN unit 401 described above) are connected via a dedicated bus 426, for example.

The CPU 412 is a system control unit including at least one processor that controls the entire mobile terminal apparatus 104. The processing of the mobile terminal apparatus 104 described below is, for example, implemented by the CPU 412 executing programs stored in the ROM 413. Note that dedicated hardware may be prepared for each item of processing. The ROM 413 stores a control program executed by the CPU 412, an embedded operating system (OS) program, and the like. In the present embodiment, in a similar manner, the CPU 412 executes the control programs stored in the ROM 413 under the management of the embedded OS stored in the ROM 413 to perform software control such as scheduling and task switching.

The RAM 414 is constituted by a Static RAM (SRAM) or the like. The RAM 414 stores data such as program control variables and the like, setting values registered by the user, mobile terminal apparatus 104 management data, and the like. Also, the RAM 414 may be used as a buffer for various types of work. The image memory 415 is constituted by a memory such as a Dynamic RAM (DRAM). The image memory 415 temporarily stores image data received via the WLAN unit 429 and image data read out from the data accumulation unit 423 for processing by the CPU 412. The non-volatile memory 422 is constituted by memory such as flash memory, for example, and continually stores data even after power to the mobile terminal apparatus 104 is turned off. Note that the memory configuration of the mobile terminal apparatus 104 is not limited to the configuration described above. For example, the image memory 415 and the RAM 414 may be shared, and data backup and the like may be performed using the data accumulation unit 423. Also, in the present embodiment, DRAM was given as an example of the image memory 415. However, another storage medium such as a hard disk or a non-volatile memory may be used.

The data conversion unit 416 executes analysis of data of various formats and data conversion, such as color conversion and image conversion. The telephone unit 417 performs control of a telephone line and implements telephone communication by processing audio data input/output via the speaker unit 424. The GPS 419 receives radio waves sent from satellites and obtains position information, for example the current latitude and longitude of the mobile terminal apparatus 104

The camera unit 421 has a function of electronically recording and encoding an image input via a lens. The image data obtained via image capture by the camera unit 421 is stored in the data accumulation unit 423. The speaker unit 424 performs control to implement a function of inputting or outputting audio for the telephone function, as well as an alarm notification and the like. The power source unit 425 is a portable battery that controls power supply to the apparatus, for example. Power source states include, for example, a battery dead state in which the battery has no remaining amount, a power-off state in which the power key 404 is not pressed, an active state in which the apparatus is normally active, and a power saving state in which the apparatus is active but is set in a power saving mode.

The display unit 420 corresponds to the display portion 402 described with reference to FIG. 4A and displays various types of input operations, the operation situation of the mobile terminal apparatus 104, status situations, and the like on the basis of control by the CPU 412. The operation unit 418 corresponds to the operation portion 403 described with reference to FIG. 4A and performs control including generating an electrical signal corresponding to a received user operation and outputting the electrical signal to the CPU 412.

The mobile terminal apparatus 104 can perform wireless communication using the WLAN unit 429 and communicate data with another device such as the MFP 100. The WLAN unit 429 converts the data into packets and transmits the packets to the other device. Also, the WLAN unit 429 restores a packet from an external other device into the original data and outputs this to the CPU 412. The WLAN unit 429 is a unit for implementing communication compliant with the WLAN standards. The WLAN unit 429 can operate in at least two communication modes in parallel, the at least two communication modes including wireless infrastructure mode and P2P (WLAN) mode. Note that the frequency range used in these communication modes may be restricted by the functions and performance of the hardware.

### Access Point Configuration

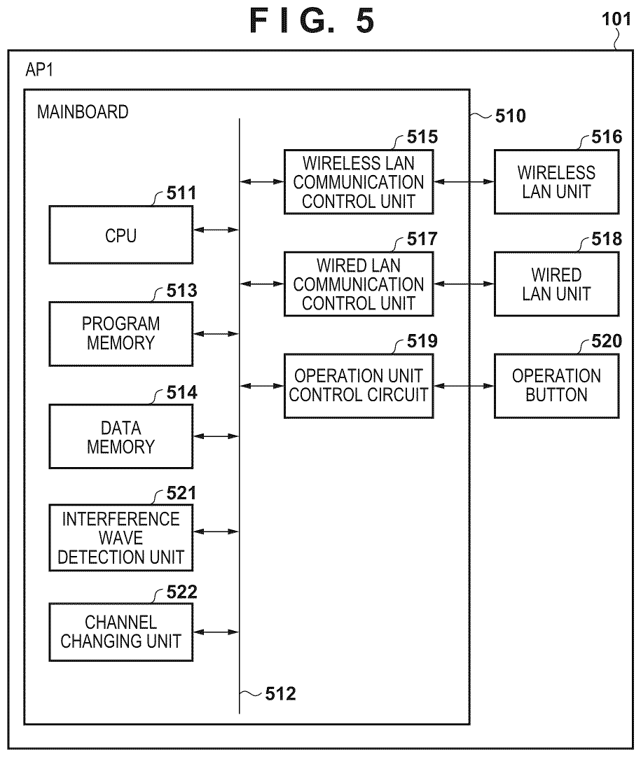

FIG. 5 is a block diagram illustrating the configuration of the AP 101 with a wireless LAN access point function. The AP 101 includes a mainboard 510 for performing control of the AP 101, a wireless LAN unit 516, a wired LAN unit 518, and an operation button 520.

A CPU 511 in the form of a microprocessor disposed on the mainboard 510 operates according to a control program stored in a program memory 513 in the form of ROM connected via an internal bus 512, data stored in a data memory 514 in the form of RAM, and the like. The CPU 511 performs wireless LAN communication with other communication terminal apparatuses by controlling the wireless LAN unit 516 via a wireless LAN communication control unit 515. Also, the CPU 511 performs wired LAN communication with other communication terminal apparatuses by controlling the wired LAN unit 518 via a wired LAN communication control unit 517. The CPU 511 can receive operations from the user via the operation button 520 by controlling an operation unit control circuit 519. The CPU 511 includes at least one processor.

Also, the AP 101 includes an interference wave detection unit 521 and a channel change unit 522. The interference wave detection unit 521 executes interference detection processing during wireless communication in a band where dynamic frequency selection (DFS) is performed. The channel change unit 522 executes processing to change the channel to use when an interference wave is detected, when an empty channel needs to be immediately changed to, and the like during wireless communication in a band where DFS is performed.

Note that the AP 102 has a configuration similar to that of the AP 101.

### P2P Communication Method

Next, in WLAN communication, the P2P (WLAN) communication method for apparatuses to wirelessly communicate directly bypassing an external access point will be described. P2P (WLAN) communication can be implemented using a plurality of methods. For example, a communication apparatus can support a plurality of modes for P2P (WLAN) communication and can perform P2P (WLAN) communication selectively using one of the plurality of modes.

The following two modes are examples of P2P modes.
SoftAP mode
Wi-Fi Direct (WFD) mode.

The communication apparatus that can execute P2P communication may be configured to support at least one of the plurality of modes. On the other hand, a communication apparatus that can perform P2P communication does not mean that all of the modes are supported, and the communication apparatus may be configured to only support a portion of the modes.

With a communication apparatus (for example, the mobile terminal apparatus 104) having a communication function using WFD, when a user operation is received via the operation unit, an application (dedicated is some cases) for implementing the communication function is invoked. Then, the communication apparatus displays a user interface (UI) screen provided by the application and prompts for a user operation. WFD communication may be performed on the basis of the user operation received in response to this.

SoftAP Mode

In SoftAP mode, the communication apparatus (for example, the mobile terminal apparatus 104) operates as a client that requests the various types of service. Another communication apparatus (for example, the MFP 100) operates as a soft AP that can execute a WLAN AP function set by the software. Note that it is sufficient that the commands and parameters transmitted and received when establishing a wireless connection between the client and the soft AP are as specified by Wi-Fi (registered trademark) standards, and thus description thereof will be omitted. Also, the MFP 100 that operates in the SoftAP mode determines the frequency band and the frequency channel as a master station. Thus, the MFP 100 can select which frequency range to use from among the 5 GHz frequency band and the 2.4 GHz frequency band and which frequency channel to use in the frequency band.

### WFD Mode

The MFP 100 may be configured to constantly active as a WFD mode master station (autonomous group owner). This make Go Negotiation processing for determining roles unnecessary. Also, in this case, the MFP 100 determines the frequency band and the frequency channel as a master station. Thus, the MFP 100 can select which frequency range to use from among the 5 GHz frequency band and the 2.4 GHz frequency band and which frequency channel to use in the frequency band.

### Wireless Infrastructure Mode

In the wireless infrastructure mode, the communication apparatuses (for example, the mobile terminal apparatus 104 and the MFP 100) that communicate with one another are connected to an external AP (for example, the AP 101) controlling the network, and communication between the communication apparatuses is performed via the AP. In other words, communication between the communication apparatuses is performed via the network formed by the external AP. The mobile terminal apparatus 104 and the MFP 100 each discover the AP 101, transmit a connection request to the AP 101, and connect to the AP 101. This enables communication between the communication apparatuses in the wireless infrastructure mode via the AP 101. Note that the plurality of communication apparatuses may connect to different APs. In this case, the communication apparatuses can communicate by data being transferred between APs. Note that it is sufficient that the commands and parameters transmitted and received when the communication apparatuses communicate via the access point are as specified by Wi-Fi standards, and thus description thereof will be omitted. Also, in this case, the AP 101 determines the frequency band and the frequency channel. Thus, the AP 101 can select which frequency range to use from among the 5 GHz frequency band, the 2.4 GHz frequency band, and the 6 GHz frequency band and which frequency channel to use in the frequency band.

### Processing in Response to Request to Change Connection Destination from AP to STA

The mobile terminal apparatus 104 and the MFP 100 support a function released as Wi-Fi Agile Multiband (trademark). Wi-Fi Agile Multiband is a function that enables the optimal environment to be selected according to the changing situation of the Wi-Fi network. Specifically, an STA such as the mobile terminal apparatus 104 and the MFP 100 and an AP such as the AP 101 exchange information relating to the network environment using the IEEE 802.11 series communication standard. By exchanging such information, when the network is congested, the AP can guide (change the connection destination) of the STA to another cellular service depending on the other AP, the frequency band, the channel, and the like.

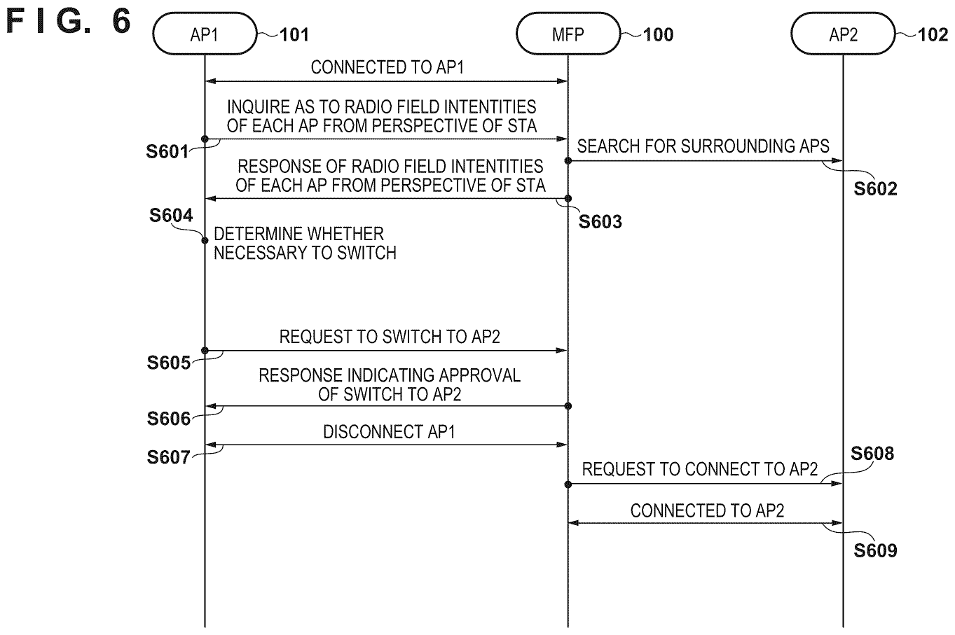

FIG. 6 is a sequence diagram of a case where the AP which is the connection destination of the MFP 100 is changed (switched) from the AP 101 to the AP 102 according to a request to change the connection destination from the AP 101. The processing executed by each apparatus in the present sequence is implement by the CPU of each apparatus reading out to the RAM and executing various types of programs stored in the ROM or similar memory of each apparatus.

In the initial state of the processing of FIG. 6, the MFP 100 has established a connection with the AP 101 in the wireless infrastructure mode. In the present embodiment, the AP 101 is the user-set AP, for example. Also, when the MFP 100 and the AP 101 connect in the wireless infrastructure mode, information of whether or not the MFP 100 supports IEEE 802.11v is obtained by the AP 101. Specifically, for example, whether the MFP 100 supports IEEE 802.11v is determined from an association request frame that is transmitted when the MFP 100 wirelessly connects to the AP 101. Then, if information indicating that the MFP 100 supports IEEE 802.11v is obtained, the AP 101 executes the following processing.

In S601, the AP 101 transmits a query (measurement request) for the radio field intensity of the APs around the MFP 100 to the MFP 100. The transmitted request may be, for example, a beacon frame request or a beacon report request. In other words, the request can use a mechanism specified in the IEEE 802.11k standard.

In S602, in response to the request received in S601, the MFP 100 receives the frames transmitted by the APs in the surroundings and measures the radio field intensity. Accordingly, the radio field intensity of each one of a plurality of APs including the AP 101 and the AP 102 is measured.

In S603, the MFP 100 transmits a list of the radio field intensities of the APs surrounding the MFP 100 measured in S602 as a response to the request received in S601. Note that as the radio field intensity response, in addition to or alternatively to the information measured in S602, information stored in the RAM 214, the non-volatile memory 215, or the like of the MFP 100 may be used. The response is transmitted as a beacon report or as measurement reports, for example.

In S604, the AP 101 determines whether or not a change of the connection destination of the MFP 100 is required on the basis of the congestion status of the network obtained by the AP 101 and the radio field intensities received in S603 from the MFP 100. Causes for the AP 101 determining that a connection destination change is necessary include too many STAs connected to the AP 101 (equal to or greater than a threshold), too much communication amount between the AP 101 and the STAs connected to the AP 101 (equal to or greater than a threshold), whether or not there is radio wave interference determined on the basis of the S/N ratio or the like, AP function stop, and the like. Also, whether or not a change of the connection destination is required may be determined on the basis of the degree of congestion (number of connected STAs, communication amount) of each AP determined using communication between APs. If it is determined that a change of the connection destination of the MFP 100 is required, the SSID of the other AP designated as candidate for the post-change connection destination of the MFP 100, the channel, and the frequency band are determined. Then, the processing proceeds to S605. Note that in the present embodiment, the SSID of the other AP designated as the change destination of the connection destination is the same SSID as the SSID of the pre-change AP.

In S605, the AP 101 transmits a connection destination AP change request (connection destination change request) to the MFP 100. The connection destination AP change request includes information of the SSID of the other AP designated as candidate for the post-change connection destination, the MAC address, the channel, and the frequency band determined in S604. Note that a plurality of SSIDs may be designated. In the present embodiment, the same SSID is set for the APs that are switching connection destination via Wi-Fi Agile Multiband, and each AP can be identified via the MAC address. Thus, the other AP designated as candidate for the post-change connection destination can be identified via the MAC address even if the SSID is the same as that of the pre-change AP. The connection destination AP change request is transmitted as a BTM request, for example. In other words, a BSS transition management (BTM) request frame specified by the IEEE 802.11v standard is transmitted. In the example of FIG. 6, the AP 102 is designated as a candidate for the post-change connection destination included in the connection destination AP change request. In other words, in the present embodiment, the SSID of the AP 101 and the SSID of the AP 102 are the same.

In S606, if following the connection destination AP change request received in S605, the MFP 100 transmits a response indicating change acknowledgement (switch acknowledgement) to the AP 101. Alternatively, suppression processing to suppress a change in the connection destination access point (connection destination AP) described below may be executed. The response is transmitted as a BTM response. In the example of FIG. 6, a response indicating acknowledgement is transmitted.

In S607, the AP 101 and the MFP 100 disconnect their connection in the wireless infrastructure mode. At this time, the connection information with the AP 101 is not deleted by the MFP 100 and is stored. In S608, the MFP 100 transmits a connection request to the AP 102 to connect to the AP 102 designated in the connection destination AP change request received in S605.

Accordingly, in S609, the MFP 100 and the AP 102 establish a connection in the wireless infrastructure mode. When a connection between the MFP 100 and the AP 102 in the wireless infrastructure mode is established, the connection information for the AP 101 is deleted.

In this manner, the MFP 100 (STA) can change the connection destination from the AP 101 to the AP 102 on the basis of a connection destination AP change request from the originally connected AP 101. The AP 101 and the AP 102 may be APs installed at different places. In other words, the MFP 100 can switch to another AP installed at a location different from that of the originally connected AP via the processing of FIG. 6. Also, the AP may support each different frequency bands of the plurality of frequency bands (two or three of the 2.4 GHz band, the 5 GHz band, and the 6 GHz band) provided by the same device. In other words, the MFP 100 can switch to a different frequency band provided by the same apparatus as the originally connected AP via the processing of FIG. 6. For example, the connection destination can be changed to an AP of a 6 GHz band on the basis of the connection destination AP change request.

Note that in an example of the present embodiment described herein, with a mechanism that is compliant with Wi-Fi Agile Multiband, a measurement request and a connection destination AP change request from the AP is transmitted and the STA responds. However, no such limitation is intended. The present embodiment is also applicable to an example using a mechanism different from the example described above in which, in response to the measurement request and the connection destination AP change request transmitted from the AP, the STA responds and changes the connection destination AP (switches, deletes, and adds the AP corresponding to the connection destination).

Depending on the state of the MFP 100 during the execution of a job or the like, a change of the connection destination AP based on a request to change the connection destination AP transmitted from the currently connected AP may not be preferable. In the present embodiment, in a case where a change of the connection destination AP based on a change request is not preferable, as processing to suppress a change of the connection destination in response to a change request, one or a combination of the following suppression processing may be executed. The following suppression processing includes processing so that a change of the connection destination AP based on a change request is not performed and processing that makes a change harder to be performed.

Suppression Processing 1: Even if the change request described in S605 is received, a change of the connection destination AP based on the received change request is not performed, and a response to the change request is not returned or a response indicating the denial of the change request (indicating that a change of the connection destination AP will not be performed) is transmitted to the currently connected AP. When a denial response is transmitted, the connection destination change priority of other STAs connected to the AP currently connected to the MFP 100 increases and the connection destination AP change priority of the MFP 100 that returned the denial response decreases. As a result, there is a possibility that the connection with the currently connected AP can be maintained. Also, in a case where a response is not returned (a case of being ignored), the currently connected AP maintains the connection with the MFP 100 as it waits for a response until the response wait time times out. Accordingly, in the case of a configuration in which connection is immediately disconnected when a certain response to a change request is received from the MFP 100, not responding, as opposed to returning a response, can increase the amount of time the connection with the currently connected AP is maintained. Thus, for example, the processing may be different depending on the reason, with a denial response being given if there is a weak reason and the change request being ignored if there is a strong reason based on the information of the change reason included in the change request. The change reason can be determined on the basis of information of which reason, including, for example, a request mode included in a BTM request, is applicable. For example, in a case where the disassociation imminent bit of the request mode or the BSS termination included bit is 1, the change reason can be determined to be a change request with a strong reason. Otherwise, it can be determined to be a weak change reason.

Suppression Processing 2: In response to the measurement request described in S601, a response (false response) is given of information relating to the radio wave reception status (signal reception status) of the non-connected APs other than the currently connected AP indicating that the radio wave status is different from the status actually measured (low signal quality). In this case, in response to receiving a measurement request, measurement may be actually performed and a response given, or measurement may not be actually performed and a response given. Specifically, in the response (beacon report or the like) described in S603, for the signal quality measured as a signal received from a non-connected AP, a value corresponding to the decreased received signal strength is used as the response and/or a value corresponding to the increased noise (signal-to-noise ratio) is used as the response. Alternatively, a response may be given with the contents not including at least one piece of information of the non- connected APs. Also, on the basis of previously measured information relating to the non-connected APs, processing may be executed so that the response has the received signal strength made into a significantly low value or the noise made into a significantly increased value. Also, measurement (AP search) may not be actually performed when a measurement request is received, and a response may be given including good received signal strength and noise status related only to the connected AP and not including information of the non-connected APs. Responding to a measurement request with a response not including information relating to the non-connected APs corresponds to content indicating that another non-connected AP could not be found even with an AP search. In this manner, a connection destination change request for changing from the currently connected AP to another AP can be suppressed from being sent. Thus, a change of the connection destination in response to a connection destination AP change request is suppressed from occurring.

Suppression Processing 3: Connection with the currently connected AP is disconnected, information indicating that the change request is not supported is notified, and the same AP is reconnected to. Specifically, the wireless connection with the currently connected AP is disconnected, and data of an association request frame including information indicating that IEEE 802.11v is not supported is generated as preparation for reconnecting the wireless connection. Thereafter, AP connection processing is executed using the generated data of the association request frame. As a result, in a case where an association request frame including information indicating that IEEE 802.11v is not supported is generated, a connection would be established with the AP as an electronic device that does not support (unsupported) an agile multiband function. This would cause the currently connected AP to recognize that the MFP 100 does not support IEEE 802.11v and cause a connection destination AP change request to not be transmitted to the MFP 100. In this manner, since a connection destination AP change request is not sent to the MFP 100, the wireless connection between the MFP 100 and the currently connected AP is likely to be maintained. Also, when the currently connected AP recognizes that the MFP 100 does not support IEEE 802.11v, transmission to the MFP 100 of a measurement request (the request described in S601) from the currently connected AP is prevented. Thus, measurement (AP search) in response to the measurement request of the MFP 100 and responding to the measurement request (processing of S603) can also be suppressed. Accordingly, the processing load and the power consumption can be reduced. Also, resources can be divided between other processes.

A state in which change of the connection destination AP based on a change request is not preferable includes a state in which print data is being received, for example. During reception of print data in the MFP 100, for example, a state occurs in which a part of the print data of the image to be printed has been received from the mobile terminal apparatus 104, the partner device) and the remaining part of the print data has not been received. In the MFP 100, printing is performed by, when the part of the print data to be printed on one sheet is received, this received part is printed (for example, one line is received then printed), then when the next part of the data is received, it is printed, and so on. During reception of the print data, if a change of the connection destination AP based on a connection destination change request is performed, a time lag occurs in conjunction with the connection destination change processing, leading to the possibility of a decrease in the print quality such as printing unevenness. Also, there is the possibility of poor communication with the mobile terminal apparatus 104, the partner device, after the connection destination change and of failure to print due to the next piece of data being unable to be received. Accordingly, during reception of print data, as processing to suppress a change of the connection destination in response to a change request, at least one processing from among the suppression processing 1 and the suppression processing 2described above may be executed or the suppression processing 3 described above may be executed before the start of print data reception.

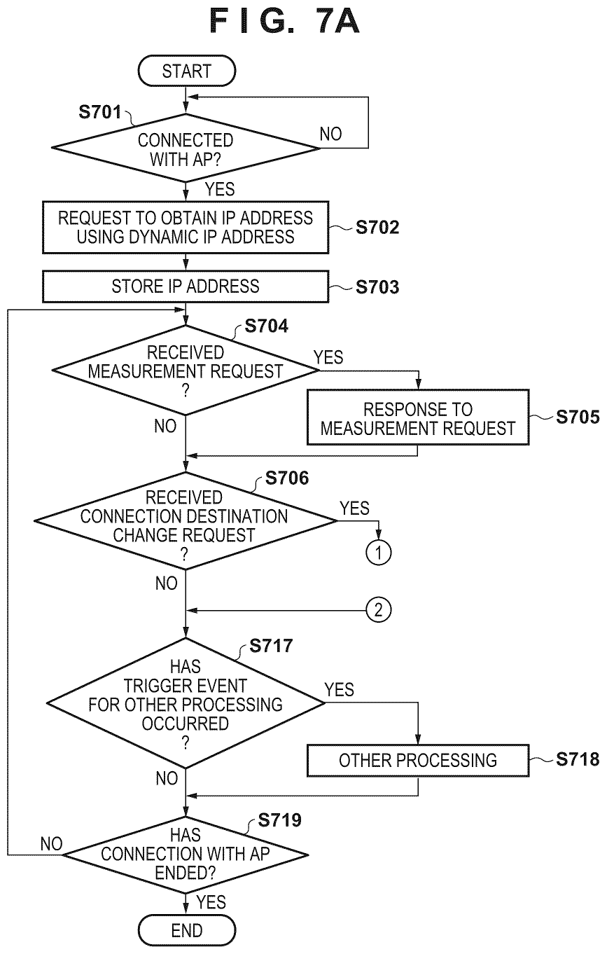

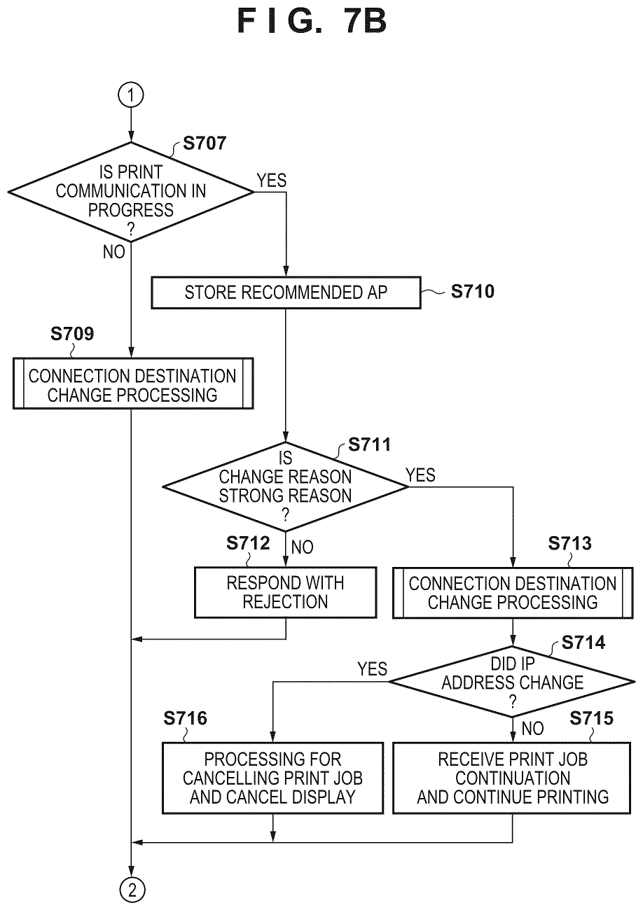

FIGS. 7A and 7B are flowcharts illustrating the processing executed in response to a connection destination AP change request according to the present embodiment. The processing in the flowchart are implemented by the CPU 212 loading a program stored in the computer-readable ROM 213 onto the RAM 214 and executing the program.

In S701, the CPU 212 determines whether or not the SSID corresponding to the connection destination AP is connected to the AP 101 where connection information such as the password and the like is pre-registered. In a case where it is determined that they are connected, the processing proceeds to S702. In a case where it is determined that they are not connected, the processing of S701 is repeated.

In S702, the CPU 212 requests the DHCP server 103 for dynamic IP address allocation. Specifically, for example, DHCP Discover is issued and transmitted. More specifically, for example, DHCP Discover is broadcast throughout the network 110. DHCP Discover is a command for requesting for IP address allocation. The DHCP server 103 that receives DHCP Discover responses with DHCP Offer directed at the MFP 100 to communicate that IP address allocation can be performed. More specifically, for example, the DHCP server 103 broadcasts DHCP Offer throughout the network 110. In the transmission source address of the DHCP Offer message, the IP address of the DHCP server 103 is set. Thus, the CPU 212 can obtain the IP address of the DHCP server 103 by receiving DHCP Offer. The CPU 212, for the DHCP server 103, designates the IP address for which allocation can be performed was communicated via DHCP Offer, issues a DHCP Request, and requests IP address allocation. If the IP address allocation designated by the MFP 100 can be performed, the DHCP server 103 confirms the IP address of the MFP 100 by responding (acknowledging) with DHCP ACK.

In S703, the CPU 212 stores the dynamic IP address allocated from the DHCP server 103 (in other words, the IP address requested via DHCP Request for which a DHCP ACK response was received) in the RAM 214. Also, the CPU 212 stores (records) the IP address of the DHCP server 103 obtained from the DHCP_Offer in at least one of the RAM 214 and the non-volatile memory 215.

In this manner, the CPU 212 establishes a connection with the AP 101 in the wireless infrastructure mode. When the MFP 100 and the AP 101 connect in the wireless infrastructure mode, information of whether or not the MFP 100 supports IEEE 802.11v is obtained by the AP 101. Here, in a case where the information indicating that the MFP 100 supports IEEE 802.11v is obtained by the AP 101, the following processing is executed.

In S704, the CPU 212 determines whether or not a query (measurement request) for the radio field intensity of the APs around the MFP 100 has been received from the AP 101. The query may include, for example, a beacon frame request or a beacon report request. In the present embodiment, either request is included. Also, the query for the radio field intensity received and confirmed in this step corresponds to what the AP 101 transmits in S601 of FIG. 6. In a case where it is determined that is has been received in S704, the processing proceeds to S705. In a case where it is determined that is has not been received, the processing proceeds to S706.

In S705, as described in S602 and S603 of FIG. 6, the CPU 212 measures the radio field intensity of the APs around the MFP 100 and transmits a list of the radio field intensities of the APs as a beacon report to the AP 101. In other words, the received measurement request is responded to.

In S706, the CPU 212 determines whether or not the connection destination AP change request received from the AP 101 has been received. In a case where it is determined that is has been received, the processing proceeds to S707. In a case where it is determined that is has not been received, the processing proceeds to S717. The change request corresponds to that described in S605 of FIG. 6.

In S707, the CPU 212 determines whether or not to perform application layer communication with the mobile terminal apparatus 104 that the MFP 100 is connected to via the connection destination AP 101. Specifically, for example, the CPU 212 determines whether or not communicate with the mobile terminal apparatus 104 to execute printing processing. In a case where it is determined to performing application layer communication, the processing proceeds to S710. In a case where it is determined to not perform application layer communication, the processing proceeds to S709. An example of communication for executing printing is used below as an example of application layer communication.

In S710, the CPU 212 stores information of a recommended AP included in the received connection destination AP change request in the RAM 214, and the processing proceeds to S711. In S711, the CPU 212 references the change reason included in the received connection destination AP change request and determines whether or not the change reason is a strong reason. In a case where the change reason is determined to be a strong reason, the processing proceeds to S713. In a case where the change reason is determined to not be a strong reason, the processing proceeds to S712. Specifically, for example, it is determined to be a strong reason in a case where a disassociation imminent bit of a request mode of a BTM request or a BSS termination included bit is 1.

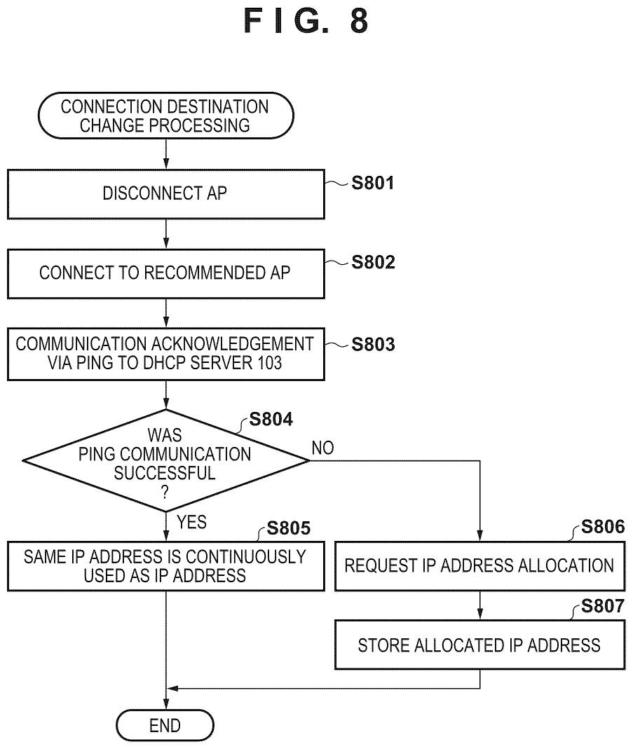

In S713, the CPU 212 executes connection destination change processing on the basis of the connection destination AP change request. The connection destination change processing will be described below using FIG. 8.

In S714, the CPU 212 determines whether or not, as a result of changing the connection destination AP via the connection destination change processing of S713, the IP address of the MFP 100 changed. In a case where it is determined that the IP address has changed, the processing proceeds to S716. In a case where it is determined that the IP address has not changed, that is, the IP address is the same as before the connection destination AP change, the processing proceeds to S715.

In S715, the CPU 212 receives a print job continuation and continues printing. Thereafter, the processing proceeds to S717. In S716, the CPU 212 executes cancel processing of the currently-printing print job. Performing job control to cancel the print job prevents data of the continuation of the print job being unable to be received and an instruction for other processing in a state of the print job being in progress being unable to be received and can restore the processing to a state in which an instruction for other processing can be received. In other words, the processing of S716 corresponds to processing to perform control to transition to a state in which an instruction for other processing can be received.

In S712, the CPU 212 transmits, to the AP 101, a response to the connection destination AP change request rejecting the change, and the processing proceeds to S717. In the case of proceeding to S712, there is not a strong reason for change. Thus, it can be assumed that, even if a change reject response is transmitted, the possibility of the AP 101 that received the response forcibly disconnecting is low. Thus, in a case where there is no strong reason for changing, the connection is maintained without the AP 101 forcibly disconnecting, and a change reject response is transmitted.

In S709, the CPU 212 executes connection destination change processing on the basis of the connection destination AP change request. The connection destination change processing will be described below using FIG. 8.

In S717, the CPU 212 determines whether or not a trigger event for causing other processing to be executed has occurred. Specifically, for example, whether or not a copy or cloud communicate instruction has been issued via a key or touch panel operation from the operation display unit 205 is determined. In a case where it is determined that a trigger event for causing other processing to be executed has occurred, the processing proceeds to S718. In a case where it is determined that a trigger event for causing other processing to be executed has not occurred, the processing proceeds to S719.

In S718, the CPU 212 executes processing in accordance with the trigger event determined to have occurred in S717. Specifically, for example, a copy (scan and print) or cloud print in accordance with an instruction is executed.

In S719, the CPU 212 determines whether or not connection with the AP has ended due to a cause other than a connection destination change via a connection destination AP change request (for example, power being turned off or the like). Here, AP may refer to the AP 101 or an AP other than the AP 101. In a case where it is determined that connection has not ended due to another cause, in other words, connection with the AP is maintained, the processing from S704 is repeated. In a case where it is determined that connection has ended due to another cause, in other words, connection with the AP has ended, the processing of FIGS. 7A and 7B ends.

FIG. 8 is a flowchart illustrating the connection destination AP change processing (connection destination change processing) of S709 and S713. The processing in the flowchart are implemented by the CPU 212 loading a program stored in the computer-readable ROM 213 onto the RAM 214 and executing the program.

In S801, after a response to the connection destination AP change request to accept the change is transmitted to the currently connected AP, the CPU 212 disconnects the connection with the currently connected AP. This processing corresponds to S606 and S607 of FIG. 6. Before the connection with the currently connected AP is disconnected, the CPU 212 may request the mobile terminal apparatus 104 via the AP 101 for the execution of a specific processing (name resolution) for the IP address of the MFP 100 after connection destination AP change on the basis of at least one of the domain name and the model specific information (model name, model number, serial number, and the like) for the MFP 100. Accordingly, even after the MFP 100 has changed the connection destination AP, the mobile terminal apparatus 104 can access with the MFP 100.

In S802, the CPU 212 connects with the recommended AP presented from the AP 101. Here, the recommended AP is the AP 102. This processing corresponds to the processing of S608 of FIG. 6. In S803, the CPU 212 performs a communication acknowledgement request via a ping directed at the IP address of the DHCP server 103 stored in S703. Specifically, for example, a ping command is transmitted to the IP address of the DHCP server 103.

In S804, the CPU 212 determines whether or not the communication acknowledgement via a ping was successful. In a case where there is a response from the DHCP server 103, it is determined that communication acknowledgement was successful, and the processing proceeds to S805. In a case where there is no response from the DHCP server 103, it is determined that communication acknowledgement was not successful, and the processing proceeds to S806. In other words, the communication acknowledgement here corresponds to confirming whether or not the MFP 100 is on the same network before and after changing the connection destination AP based on a change request.

In S805, the CPU 212 continues to use the same IP address as before the change of the connection destination AP based on the change request as the IP address of the MFP 100. In other words, control is performed to not execute the predetermined processing of S806 to S807 for requesting allocation of an IP address.

In S806, the CPU 212 executes processing for requesting the DHCP server 103 for allocation of an IP address. Specifically, for example, the CPU 212 first broadcasts DHCP Discover throughout the network (hereinafter referred to as a network 2) the MFP 100 belongs to after the change of connection destination AP based on the change request. A DHCP server (hereinafter referred to as a second DHCP server) on the network 2 that received the DHCP Discover broadcasts DHCP Offer as the response. In the transmission source address of the DHCP Offer, the IP address of the second DHCP server is set. Thus, the CPU 212 can obtain the IP address of the second DHCP server by receiving DHCP Offer. The CPU 212, for the second DHCP server, designates the IP address for which allocation can be performed was communicated via DHCP Offer, issues a DHCP Request, and requests IP address allocation. At this time, regardless of whether or not the IP address for which allocation can be performed was communicated via DHCP Offer is the same as the IP address before the change of the connection destination AP, the CPU 212 issues DHCP Request with the communicated IP address set as the IP address to be used by the MFP 100.

Specifically, for example, if the IP address stored in S703 is IP address A and the IP address for which allocation can be performed was communicated via DHCP Offer in S806 is IP address B, the CPU 212 designates the IP address B and issues a DHCP Request. Also, if the IP address stored in S703 is IP address A and the IP address for which allocation can be performed was communicated via DHCP Offer in S806 is IP address A, the CPU 212 designates the IP address A and issues a DHCP Request. If the IP address allocation designated by the MFP 100 can be performed, the second DHCP server confirms the IP address of the MFP 100 by responding (acknowledging) with DHCP_ACK.

In S807, the CPU 212 stores the IP address allocated by the second DHCP server (in other words, the IP address requested via DHCP Request in S806 for which a DHCP ACK response was received) in the RAM 214. At this time, the IP address stored in S703 is cleared by being overwritten by the IP address stored in S807. Specifically, for example, if the IP address stored in S703 is IP address A and the IP address that requested via DHCP Request and received a DHCP ACK response is IP address B, the IP address A is cleared by being overwritten by the IP address B. Also, in S807, the IP address of the second DHCP server obtained from the DHCP Offer is stored in at least one of the RAM 214 and the non-volatile memory 215.

The processing of S806 may be executed as follows. In other words, the CPU 212, for the second DHCP server, designates the IP address for which allocation can be performed was communicated via DHCP Offer, issues a DHCP Request, and requests IP address allocation. At this time, regardless of whether or not the IP address for which allocation can be performed was communicated via DHCP Offer is the same as the IP address before the change of the connection destination AP, the CPU 212 issues DHCP Request with the IP address of before the change of the connection destination AP stored in S703 set as the IP address to be used by the MFP 100. Specifically, for example, if the IP address stored in S703 is IP address A and the IP address for which allocation can be performed was communicated via DHCP Offer is IP address B, the CPU 212 designates not the IP address B but temporarily the IP address A and issues a DHCP Request. In a case where the result of the DHCP Request is reception of an approval DHCP ACK from the second DHCP server, the IP address of before the change of the connection destination AP (in other words, the IP address A) is continued to be used. Then, in this case, in S807, the IP address A is stored. On the other hand, in a case where a response of rejection is received from the second DHCP server, the CPU 212, for the second DHCP server, designates the IP address B for which allocation can be performed was communicated via DHCP Offer, issues a DHCP Request, and requests IP address allocation. Then, in this case, in S807, the CPU 212 stores the IP address that requested via DHCP Request and received the DHCP ACK response (in other words, the IP address B), in the RAM 214.

In the processing described above, yes being determined in S804 and communication acknowledgement being successful with the DHCP server 103 that was on the network before the change of the connection destination AP means that the MFP 100 belongs to the same network as before the change of the connection destination AP even after the change of the connection destination AP. In other words, the connection destination AP is in the same network before and after the change. If it is the same network, there is no problem continuing to use same IP address as before the change of the connection destination AP as the IP address of the MFP 100. Thus, in the present embodiment, in such a case, the processing of S806 and S807 for requesting the DHCP server for allocation of a new IP address can be omitted. This can reduce interruptions to the communication between another device in the network (for example, the mobile terminal apparatus 104) and the MFP 100 (for example, removing or shortening the interruption period) caused by switching the IP address of the MFP 100.

On the other hand, no being determined in S804 and communication acknowledgement not being successful with the DHCP server 103 that was on the network before the change of the connection destination AP means that the MFP 100 belongs to a different network to the network before the change of the connection destination AP after the change of the connection destination AP. In other words, the connection destination AP is in a different network before and after the change. In the case of different networks, it is problematic if the same IP address as before the change of the connection destination AP is continuously used as the IP address of the MFP 100. For example, there is a possibility that the IP address of the MFP 100 before the change of the connection destination AP is used by another device in the network after the change of the connection destination AP, and that communication may fail due to overlap with the IP address. Thus, in the present embodiment, in such cases, a request for new IP address allocation is sent to the DHCP server. In other words, the processing of S806 and S807 is executed.

Note that in the example described above, in S803, communication acknowledgement directed to the DHCP server 103 is performed via a ping. However, a different process may be used if, after the change of the connection destination AP, it can be confirmed whether or not the MFP 100 belongs to the same network as before the change of the connection destination AP.

As a communication acknowledgement method that does not use a ping, for example, an address resolution protocol (ARP) request mechanism may be used. In this case, the MFP 100 performs TCP/IP communication and transmits an ARP request message via a broadcast. At this time, the IP address of the DHCP server 103 is set in the message. When the DHCP server 103 receives the message, an ARP reply to returned to the MFP 100, thus allowing the MFP 100 to be determined as belonging to the same network. In a case where the terminal, DHCP server, or the like corresponding to the IP address set in the ARP request does not exist in the network, a reply to not returned. Thus, in this case, the MFP 100 can be determined as not belonging to the same network as before the change of the connection destination AP.

Also, communication acknowledgement may be performed directed at, not the DHCP server, but an external device that existed in the network belonged to before the change of the connection destination AP. In a case where communication is confirmed, the MFP 100 can be determined as belonging to the same network before and after the change of the connection destination AP. In a case where communication is not confirmed, the MFP 100 can be determined as belonging to a different network before and after the change of the connection destination AP. For example, as the target for communication acknowledgement, for example, the mobile terminal apparatus 104, the IP address of a default gateway, or the IP address of a router may be used.

Also, for example, in a case where the host name of the mobile terminal apparatus 104 or the IP address is registered in the MFP 100, the mobile terminal apparatus 104 may be targeted for communication acknowledgement. In a case where the host name of the mobile terminal apparatus 104 or the IP address is registered in the MFP 100, for example, it is registered as a destination for transmitting a scanned file. Even with such a configuration, whether or not the MFP 100 belongs to be the same network before and after the change of the connection destination AP can be determined. In a case where the host name is stored, name resolution can be performed via link-local multicast name resolution (LLMNR), NetBIOS, or mDNS. Here, that name resolution can be performed means that there was a response from the host itself, which means that the mobile terminal apparatus 104 belongs to the same network. In other words, it can be determined that the network is the same as before the change of the connection destination AP. In a case where the IP address is stored, communication acknowledgement via a ping is performed directed to the IP address of the mobile terminal apparatus 104. If the communication is confirmed, it means that the mobile terminal apparatus 104 belongs to the same network. In other words, it can be determined that the network is the same as before the change of the connection destination AP.

The processing of S707 described above is processing performed during reception of print data. However, the processing of FIGS. 7A and 7B can be applied during reception of data other than print data or during transmission of other data. For example, the processing of FIGS. 7A and 7B can be applied when transmitting an image (image data) of a document scanned by the reading unit 219 to the mobile terminal apparatus 104 via AP. In this case, in a case where yes is determined in S706 of FIG. 7A described above, instead of or in addition to the determination of S707, it may be determined whether or not transmission after scanning is in progress. In this case, if it is determined that transmission after scanning is not in progress, the processing proceeds to S709. In a case where it is determined that transmission after scanning is in progress, the processing of S710 to S716 is executed with “transmission after scanning” substituting “print” in the example described above. Also, for example, the processing of FIGS. 7A and 7B can be applied when data for fax (fax data) is transmitted to an external device via AP. In this case, in a case where yes is determined in S706 of FIG. 7A described above, instead of or in addition to the determination of S707, it may be determined whether or not fax transmission is in progress. In this case, if it is determined that fax transmission is not in progress, the processing proceeds to S709. In a case where it is determined that fax transmission is in progress, the processing of S710 to S716 is executed with “fax transmission” substituting “print” in the example described above.

The various types of control described above performed by the CPU 212 may be performed by a single piece of hardware or the processing may be shared by a plurality of pieces of hardware (for example, a plurality of processors and circuits) to perform control of the entire apparatus. Also, in the embodiment described above, an example of the present invention applied to an MFP has been described. However, no such limitation is intended, and any wireless device that can function as an STA to execute processing in response to a change request from an AP may be used. In other words, the present invention is applicable to a personal computer, a PDA, a tablet terminal, a smartphone or similar mobile phone terminal, a music player, a game console, an electronic book reader, a smartwatch, and various types of measurement apparatuses (sensor apparatuses) such as a thermometer and a hygrometer. Also, the present invention is applicable to a digital camera (including a still camera, a video camera, a network camera, and a security camera), a printer, a scanner, and a drone. Also, the present invention is applicable to an image output apparatus, an audio output apparatus (for example, a smart speaker), a media streaming player, and a wireless LAN client (adapter) that can connect to a USB terminal or a LAN cable terminal. An image output apparatus includes an apparatus such as a set top box, for example, that obtains (downloads) moving image and still images from the Internet specified by a URL in an instruction from an electronic device and outputs these to a display device connected via a HDMI (registered trademark) image output terminal or the like. In this manner, streaming playback is achieved on a display device, and mirroring display (displaying content displayed on an electronic device also on a display device) is achieved. Also, the image output apparatus includes a television, hard disk recorder, Blu-ray recorder, DVD recorder, or similar media player; a head-mounted display, a projector, a television, a display apparatus (monitor), and a signage apparatus. Also, the present invention is applicable to a device that can connect via Wi-Fi to an air conditioner, a refrigerator, a washing machine, a vacuum cleaner, an oven, a microwave oven, a lighting fixture, a heating device, a cooling device, or any so-called smart home appliances.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™M), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-198525, filed Nov. 22, 2023, which is hereby incorporated by reference herein in its entirety.

What is claimed is:

1. An electronic device comprising:
at least one memory and at least one processor which function as:
a reception unit configured to receive a change request for a connection destination AP from a currently connected access point (AP);
a change unit configured to change a connection destination AP on a basis of the change request;
a confirmation unit configured to, when changing via the change unit, confirm whether or not communication can be performed with a specific external device communicated with before an AP change via an AP after change; and
a control unit configured to perform control so that, relating to a result of confirmation by the confirmation unit,
in a case where communication cannot be performed with the specific external device, a specific processing for requesting IP address allocation is executed, and
in a case where communication can be performed with the specific external device, the specific processing is not executed.

2. The electronic device according to claim 1, wherein the specific processing includes at least one of transmitting DHCP Discover and transmitting DHCP Request.

3. The electronic device according to claim 1, wherein the specific external device is a DHCP server communicated with before an AP change.

4. The electronic device according to claim 1, wherein the specific external device is a default gateway, a router, or a mobile terminal apparatus communicated with before an AP change.

5. The electronic device according to claim 1, wherein the confirmation unit confirms whether or not communication with the specific external device can be performed using communication acknowledgement via a ping.

6. The electronic device according to claim 1, wherein after a connection destination AP is changed on a basis of the change request during a specific processing executed in conjunction with an exchange of data with another device via a currently connected AP, in a case where a result of confirmation by the confirmation unit is that communication can be performed with the specific external device, the control unit performs control to continue executing the specific processing.

7. The electronic device according to claim 6, wherein after a connection destination AP is changed on a basis of the change request during a specific processing executed in conjunction with an exchange of data with another device via a currently connected AP, in a case where a result of confirmation by the confirmation unit is that communication cannot be performed with the specific external device, the control unit performs control to cancel the specific processing and transition to a state that can receive another processing instruction.

8. The electronic device according to claim 6, wherein the specific processing is at least one print, transmission after scanning, and fax.

9. The electronic device according to claim 1, wherein the electronic device connects to an AP and executes processing compliant with IEEE 802.11ax standard.

10. The electronic device according to claim 1, wherein the electronic device can execute at least one of processing compliant with orthogonal frequency-division multiple access (OFDMA) and processing compliant with target wake time (TWT).

11. The electronic device according to claim 1, wherein the electronic device can change a connection destination to an AP of 6 GHz band by changing a connection destination on a basis of the change request.

12. The electronic device according to claim 1, further comprising:
a printer configured to execute printing processing based on print data received via a currently connected AP.

13. A control method executed by an electronic device comprising:
receiving a change request for a connection destination AP from a currently connected access point (AP);
changing a connection destination AP on a basis of the change request;
when changing, confirming whether or not communication can be performed with a specific external device communicated with before an AP change via an AP after change; and
performing control so that, relating to a result of the confirming,
in a case where communication cannot be performed with the specific external device, a specific processing for requesting IP address allocation is executed, and
in a case where communication can be performed with the specific external device, the specific processing is not executed.

14. A non-transitory computer-readable storage medium that stores one or more programs including instructions, which when executed by one or more processors of an electronic device, cause the electronic device to:
receive a change request for a connection destination AP from a currently connected access point (AP);
change a connection destination AP on a basis of the change request;
when changing, confirm whether or not communication can be performed with a specific external device communicated with before an AP change via an AP after change; and
perform control so that, relating to a result of the confirming,
in a case where communication cannot be performed with the specific external device, a specific processing for requesting IP address allocation is executed, and
in a case where communication can be performed with the specific external device, the specific processing is not executed.
